(19) United States
(12) Patent Application Publication
(10) Pub. No.: US 2026/0229104 A1
(43) Pub. Date: Aug. 6, 2026

(54) APPARATUS FOR FIRE DETECTION AND METHOD THEREOF

(71) Applicants: Hyundai Motor Company, Seoul (KR); Kia Corporation, Seoul (KR)

(72) Inventors: Yoon Sung Choi, Hwaseong-Si (KR); Hyo Kyung Lee, Hwaseong-Si (KR); Ki Young Lee, Hwaseong-Si (KR)

(21) Appl. No.: 19/298,704

(22) Filed: Aug. 13, 2025

(30) Foreign Application Priority Data
Feb. 5, 2025 (KR) 10-2025-0014794

(51) Int. Cl. G08B 17/103; G08B 17/12

(52) U.S. Cl. CPC G08B 17/103; G08B 17/125

(57) ABSTRACT

A fire detection apparatus and a method thereof are provided. The fire detection apparatus may include: a camera mounted on a vehicle; a processor; and a memory. The memory may store at least one instruction that is configured, when executed by the processor communicating with the memory, to cause the fire detection apparatus to: obtain, via the camera, one or more images of an environment of the vehicle; detect, based on at least one of an object detection model or a feature point extraction algorithm, an object in the one or more images; determine, based on an object classification type of the object, presence of a fire event; and cause, based on the determined presence of the fire event, the vehicle to perform one or more remedial actions.

### CROSS-REFERENCE TO RELATED APPLICATION

This application claims the benefit of and priority to Korean Patent Application No. 10-2025-0014794, filed in the Korean Intellectual Property Office on February 5, 2025, the entire contents of which are incorporated herein by reference.

### TECHNICAL FIELD

The present disclosure relates to an apparatus for fire detection and a method thereof, and more particularly, relates to a technology for detection of vehicle-related fires.

### BACKGROUND

One of the design challenges that face electric vehicles is the battery-related fire risk that may be miniscule yet non-negligible.

If a fire breaks out, for example, while an electric vehicle is parked in a garage, it can be difficult to discover and report the incidence to the authorities in a timely manner and to cope with the fire. A delayed response may further increase the extent of damage the fire may cause.

Accordingly, there exists a need for a technology for more efficiently and more immediately detecting the fire that may start at or around a parked electric vehicle (e.g., a fire due to a battery).

The matters described in this Background section are only for enhancement of understanding of the background of the disclosure, and should not be taken as acknowledgement that they correspond to prior art already known to those skilled in the art.

### SUMMARY

The present disclosure has been made to solve the above-mentioned problems occurring in at least some implementations while advantages achieved by those implementations are maintained intact.

An aspect of the present disclosure provides an apparatus for fire detection using a camera mounted on a vehicle and a method thereof.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a fire detection apparatus may include: a camera mounted on a vehicle; a processor; and a memory. The memory may store at least one instruction that is configured, when executed by the processor communicating with the memory, to cause the fire detection apparatus to: obtain, via the camera, one or more images of an environment of the vehicle; detect, based on at least one of an object detection model or a feature point extraction algorithm, an object in the one or more images; determine, based on an object classification type of the object, presence of a fire event; and cause, based on the determined presence of the fire event, the vehicle to perform one or more remedial actions.

The at least one instruction may be configured, when executed by the processor communicating with the memory, to cause the fire detection apparatus to obtain the one or more images by: obtaining the one or more images while the vehicle is in a parked state.

The at least one instruction may be configured, when executed by the processor communicating with the memory, to cause the fire detection apparatus to obtain the one or more images by: obtaining, via the camera, the one or more images at predetermined time intervals.

The object detection model may include an artificial intelligence-based model that is pre-trained to detect objects in photographic images.

The at least one instruction may be configured, when executed by the processor communicating with the memory, to cause the fire detection apparatus to detect the object by: inputting the one or more images to the object detection model.

The at least one instruction may be configured, when executed by the processor communicating with the memory, to cause the fire detection apparatus to detect the object by: extracting, from the one or more images and using the feature point extraction algorithm, a feature point and a descriptor of the feature point; and detecting the object corresponding to the feature point and the descriptor by comparing pre-determined reference object information with the feature point and the descriptor.

The at least one instruction may be configured, when executed by the processor communicating with the memory, to further cause the fire detection apparatus to, after detecting the object, determine, via a battery management system of the vehicle, whether at least one battery parameter of a battery is within a predetermined range.

The at least one instruction may be configured, when executed by the processor communicating with the memory, to cause the fire detection apparatus to determine presence of the fire event by: determining presence of the fire event further based on whether the at least one battery parameter of the battery is within the predetermined range.

The vehicle may be a first vehicle. The at least one instruction may be configured, when executed by the processor communicating with the memory, to cause the fire detection apparatus to determine presence of the fire event by: determining, based on the at least one battery parameter of the battery being outside the predetermined range and the object classification type being smoke or flame, presence of the fire event at a second vehicle different from the first vehicle.

The at least one instruction may be configured, when executed by the processor communicating with the memory, to cause the fire detection apparatus to determine presence of the fire event by: determining, based on the at least one battery parameter of the battery being outside the predetermined range and the object classification type being smoke or flame, presence of the fire event at the vehicle.

According to one or more example embodiments of the present disclosure, a method performed by an apparatus of a vehicle may include: obtaining, via a camera mounted on the vehicle, one or more images of an environment of the vehicle; detecting, based on at least one of an object detection model or a feature point extraction algorithm, an object in the one or more images; determining, based on an object classification type of the object, presence of a fire event; and causing, based on the determined presence of the fire event, the vehicle to perform one or more remedial actions.

Obtaining the one or more images may include: obtaining the one or more images while the vehicle is in a parked state.

Obtaining the one or more images may include: obtaining, via the camera, the one or more images at predetermined time intervals.

The object detection model may include an artificial intelligence-based model that is pre-trained to detect objects in photographic images.

Detecting the object may include: inputting the one or more images to the object detection model.

Detecting the object may include: extracting, from the one or more images and using the feature point extraction algorithm, a feature point and a descriptor of the feature point; and detecting the object corresponding to the feature point and the descriptor by comparing pre-determined reference object information with the feature point and the descriptor.

The method may further include: after the detecting of the object, determining, via a battery management system of the vehicle, whether at least one battery parameter of a battery is within a predetermined range.

Determining presence of the fire event may include: determining presence of the fire event further based on whether the at least one battery parameter of the battery is within the predetermined range.

The vehicle may be a first vehicle. Determining presence of the fire event may include: determining, based on the at least one battery parameter of the battery being outside the predetermined range and the object classification type being smoke or flame, presence of the fire event at a second vehicle different from the first vehicle.

According to one or more example embodiments of the present disclosure, a vehicle may include: a camera; a temperature sensor; a processor; and a memory. The memory may store at least one instruction that is configured, when executed by the processor communicating with the memory, to cause the vehicle to: obtain, via the camera, one or more images of an environment of the vehicle; detect, based on at least one of an object detection model or a feature point extraction algorithm, an object in the one or more images; determine, based on a measured temperature of the temperature sensor and based on an object classification type of the object, presence of a fire event; and cause, based on the determined presence of the fire event, the vehicle to perform an autonomous driving operation of the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of an example fire detection apparatus;

FIGS. 2, 3, 4, 5, 6, 7, and 8 are flowcharts illustrating a fire detecting method which is performed by an example fire detection apparatus;

FIG. 9 is a diagram illustrating a result of detecting an object included in an image by using an example algorithm for object recognition;

FIG. 10 is a diagram illustrating a result of detecting an object included in an image by using an example algorithm for object recognition; and

FIG. 11 illustrates an example computing system.

### DETAILED DESCRIPTION

Hereinafter, one or more example embodiments of the present disclosure will be described in detail with reference to the accompanying drawings. In adding the reference numerals to the components of each drawing, it should be noted that the identical component is designated by the identical numerals even if they are displayed on other drawings. Further, in describing the example embodiment(s) of the present disclosure, a detailed description of well-known features or functions may be omitted in order not to unnecessarily obscure the gist of the present disclosure.

In describing the components of the example embodiment(s) according to the present disclosure, terms such as first, second, “A”, “B”, (a), (b), and the like may be used. These terms are merely intended to distinguish one component from another component, and the terms do not limit the nature, sequence or order of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., detecting an emergency situation such as a fire event) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.). One or more auxiliary devices (e.g., engine brake, exhaust brake, hydraulic retarder, electric retarder, regenerative brake, etc.) may also be controlled, for example, based on one or more features (e.g., detecting an emergency situation such as a fire event) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., detecting an emergency situation such as a fire event) described herein.

Minimum risk maneuver (MRM) operation(s) may also be controlled, for example, based on one or more features (e.g., detecting an emergency situation such as a fire event) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., detecting an emergency situation such as a fire event) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., detecting an emergency situation such as a fire event) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.). Based on determining a fire event, an operation control (e.g., remedial actions) for autonomous driving may be, for example, exiting (e.g., escaping) an area or location (e.g., parking lot) associated with the fire event by engaging one or more autonomous driving features. The operation control (e.g., remedial actions) may also include, for example, cooling down the battery to decrease the battery temperature, sending an emergency message, etc.

A vehicle that is equipped with a fire detection device may be referred to as an ego vehicle or a host vehicle. The ego vehicle may be, for example, an autonomous vehicle (also referred to as a self-driving car, an autonomous car (AC), a driverless car, a robotaxi, a robotic car, or a robo-car). A car that is ahead of the ego vehicle (e.g., in the same driving lane as the ego vehicle) may be referred to as a vehicle in front (e.g., a vehicle directly in front), a vehicle ahead (e.g., a vehicle directly ahead), a lead vehicle, a leading vehicle, or a preceding vehicle. A car that follows the ego vehicle (e.g., in the same driving lane as the ego vehicle) may be referred to as a car behind, a trailing vehicle, a following vehicle, or a succeeding vehicle. An adjacent vehicle may refer to any vehicle located (e.g., driving or parked) in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle (including any parked vehicles) that is near the ego vehicle (e.g., within a threshold distance away from the ego vehicle). The target vehicle may be any vehicle that a fire detection apparatus monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a parked vehicle, a vehicle driving by, an adjacent vehicle (e.g., regardless of the distance from the ego vehicle and/or regardless of whether there are intervening vehicle(s) between the target vehicle and the ego vehicle), etc. A target vehicle may also be referred to as a surrounding vehicle, a nearby vehicle, an external vehicle, another vehicle (other vehicles), and so forth.

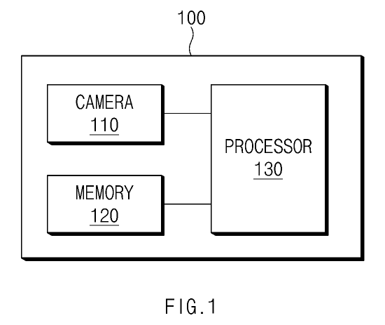

Hereinafter, one or more example embodiments of the present disclosure will be described in detail with reference to FIGS. 1 through 11.

FIG. 1 is a block diagram illustrating a configuration of an example fire detection apparatus.

A fire detection apparatus 100 may be a computing device capable of performing calculation (computation). For example, the fire detection apparatus 100 may be mounted on a smartphone, a robot, a vehicle, and/or a mobility device. For example, the fire detection apparatus 100 may be implemented within the vehicle. In this case, the fire detection apparatus 100 may be integrally formed with internal control units of the vehicle; alternatively, the fire detection apparatus 100 may be implemented with a separate device and may be connected to the control units of the vehicle by a separate connection means.

Referring to FIG. 1, the fire detection apparatus 100 may include a camera 110, a memory 120, and a processor 130. The configuration of the fire detection apparatus 100 is not limited to the example illustrated in FIG. 1. For example, the fire detection apparatus 100 may further include some components, or some of the components of the fire detection apparatus 100 may be omitted. The fire detection apparatus 100 may further include an output device (not illustrated). For example, an output device of the fire detection apparatus 100 may include a display included in the vehicle. The display may visually display information (e.g., information of a camera mounted on a vehicle or an image captured by the camera) associated with the vehicle.

The camera 110 may include at least one of image sensors such as a charge coupled device (CCD) image sensor, a complementary metal oxide semi-conductor (CMOS) image sensor, a charge priming device (CPD) image sensor, and/or a charge injection device (CID) image sensor. The camera 110 may include an image processor which performs image processing on an image obtained (acquired) by the image sensor, such as noise cancellation, color reproduction, file compression, image quality control, and/or saturation control.

The memory 120 may store information of any suitable format, which the processor 130 generates or determines, and/or information of a suitable format, which a communication device (not illustrated) receives. For example, the memory 120 may store an algorithm for object recognition (e.g., an object detection model based on artificial intelligence and/or a feature point extraction algorithm). For another example, the memory 120 may store reference object information. The memory 120 may operate under control of the processor 130.

The memory 120 may include at least one type of storage medium such as a flash memory type memory, a hard disk type memory, a multimedia card micro type memory, a card type memory (e.g., a secure digital (SD) card and/or an XD card), a random access memory (RAM), a static random access memory (SRAM), a read-only memory (ROM), an electrically erasable programmable ROM (EEPROM), a programmable ROM (PROM), a magnetic memory, a magnetic disk, and/or an optical disk. The fire detection apparatus 100 may operate in connection with web storage which performs a storage function of the memory 120 on the Internet. The above description associated with the memory 120 is provided only as an example, and the present disclosure is not limited thereto.

The processor 130 may be implemented with one or more cores and may include a processor for performing operations associated with data processing of a central processing unit (CPU), a general purpose graphics processing unit (GPGPU), a tensor processing unit (TPU), etc. of the fire detection apparatus 100.

The processor 130 may perform computation for learning of an artificial intelligence-based model. For example, the processor 130 may perform computation for learning of the artificial intelligence-based model, such as processing of input data for learning in the deep learning (DL), extraction of features from the input data, error calculation, and update of weights of the artificial intelligence-based model using backpropagation. The processor 130 may process the learning of a network function. Also, the processor 130 may perform learning of the network function and data processing of the network function by using processors of a plurality of computing devices together.

The processor 130 may generally control all operations of the fire detection apparatus 100. The processor 130 may process a signal, data, information, etc. input or output via components included in the fire detection apparatus 100 or may run an application program stored in the memory 120, and thus, the processor 130 may provide information appropriate for the user or may process a function appropriate for the user.

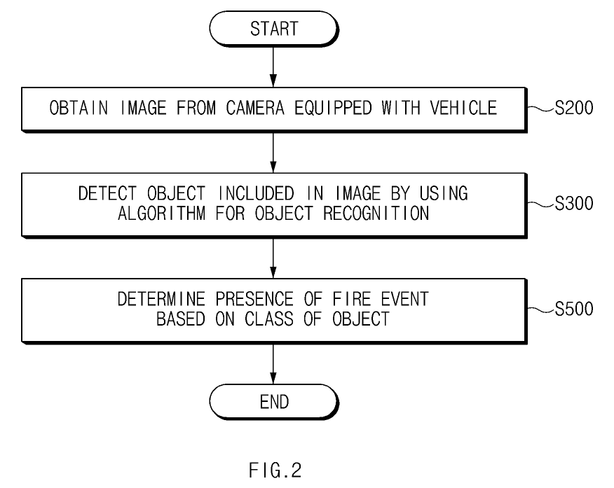

One or more example fire detecting methods are described herein in detail with reference to FIGS. 2 through 8. FIGS. 2 through 8 are flowcharts illustrating a fire detecting method which is performed by an example fire detection apparatus.

Herein, it is assumed that the fire detection apparatus 100 of FIG. 1 performs the process of FIGS. 2 through 8. Also, in the description to be given with reference to FIGS. 2 through 8, operations which are described as being performed by a device may be understood as being controlled by the processor 130 of the fire detection apparatus 100.

Referring to FIG. 2, the fire detection apparatus 100 may obtain one or more images (e.g., a photographic images) from the camera 110 mounted on the vehicle (S200). The one or more images may be of an environment (e.g., internal environment or external environment) of the vehicle.

The image may be an image of an object, which is made by refraction or reflection of a light. The image may be a visual representation formed by rays arranged on a plane or in a space or by a medium such that information is visualized. For example, the image may include a still image, a moving image, etc. However, kinds of the image are not limited thereto. The image may correspond to information obtained by a camera.

The camera 110 may include a built-in CAM provided in the vehicle and/or an autonomous driving camera.

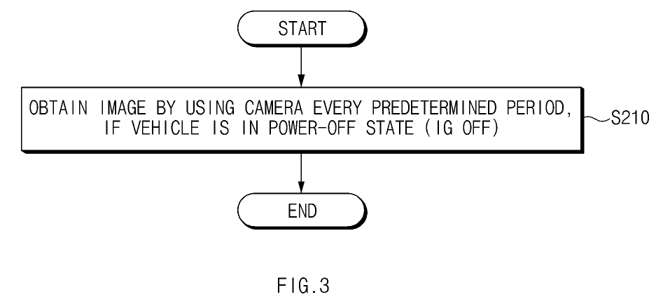

Referring to FIG. 3, if the vehicle is in a power-off state (IG OFF), the fire detection apparatus 100 may obtain an image by using a camera every predetermined period (e.g., at predetermined time intervals, such as every one minute) (S210).

The power-off state may refer to a state in which a power of the vehicle is turned off or reduced. In the power-off state, only a minimum or reduced power may be used, and the main electric devices (e.g., a drive train, a dashboard, an infotainment system, an air conditioning system, etc.) of the vehicle may be nonoperational and/or in a low power mode. For an internal combustion engine vehicle, for example, the ignition may be off when the vehicle is in the power-off state. The power-off state may be engaged, for example, when a vehicle is parked. The power-off state may also be referred to as a low-power state, low-power mode, park mode, parked state, etc. If the vehicle is in the power-off state, the vehicle may be in a parked situation. Accordingly, in the situation where the vehicle is parked, the fire detection apparatus 100 may be activated and detect a fire (also referred to as a fire event, a fire incident, a fire breakout, an uncontrolled fire, etc.) by obtaining an image by using a camera at given time intervals and detecting an object of the image.

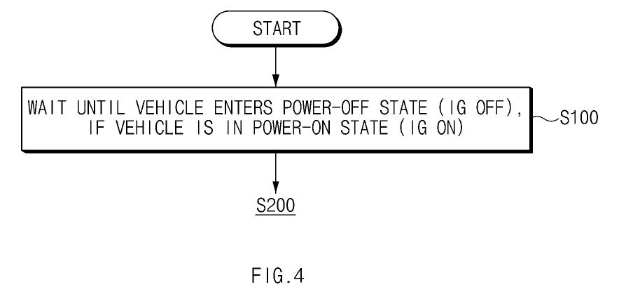

The fire detection apparatus 100 may not obtain an image while the vehicle is driving. For example, referring to FIG. 4, before an image is obtained from the camera mounted on the vehicle (e.g., before S200), if the vehicle is in a power-on state (IG ON), the fire detection apparatus 100 may wait until the vehicle enters the power-off state (IG OFF) (S100).

The power-on state, which is a state where the power of the vehicle is turned on, may be a state in which most (e.g., a predetermined set of) electric devices of the vehicle are activated. In the power-on state, for example, the vehicle may be ready for driving operation (e.g., the vehicle is ready to move with a press of an accelerator pedal). For an internal combustion engine vehicle, for example, the ignition may be on if the vehicle is in the power-on state. The power-on state may also be referred to as a ready-to-drive state, ready state, drive mode, driving state, etc. Accordingly, if the vehicle is driving, the fire detection apparatus 100 may not perform the process for fire detection; the fire detection apparatus 100 may perform the process for fire detection only in the vehicle-parked situation.

Returning to FIG. 2, the fire detection apparatus 100 may detect an object included in the image by using an algorithm for object recognition (S300).

The algorithm for object recognition may include at least one of an artificial intelligence-based object detection model and a feature point extraction algorithm.

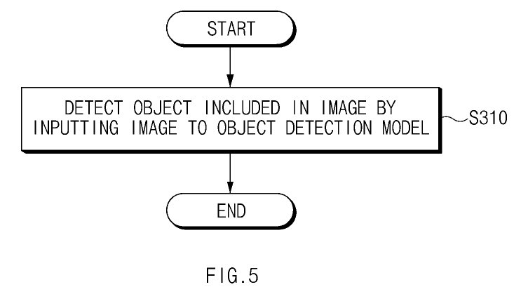

Referring to FIG. 5, the fire detection apparatus 100 may detect the object included in the image by inputting the image to the object detection algorithm (S310).

In the specification, the artificial intelligence-based model may be implemented with a set of interconnected calculation units capable of being generally referred to as a “node”. The nodes may be referred to as “neurons”. The artificial intelligence-based model is implemented to include at least one or more nodes. The nodes (or neurons) constituting the artificial intelligence-based model may be interconnected by one or more links.

In the artificial intelligence-based model, one or more nodes connected via the link may form a relative relationship between an input node and an output node. The concept of the input node and the output node may be relative. For example, an arbitrary node having an output node relationship with one node may have an input node relationship with any other node, and vice versa. As described above, the relationship between the input node and the output node may be generated based on the link. One or more output nodes may be connected to one input node via links, and vice versa.

In the relationship between the input node and the output node connected via one link, a value of data of the output node may be determined based on data input to the input node. Herein, the link which connects the input node and the output node may have a weight. The weight may be variable and may be varied by the user or the algorithm for the artificial intelligence-based model to perform a required function. For example, if one or more input nodes are connected to one output node by respective links, the output node may determine an output node value based on values input to input nodes connected to the output node and a weight set to the link corresponding to each of the input nodes.

As described above, one or more nodes may be interconnected via one or more links to form the relationship between the input node and the output node in the artificial intelligence-based model. In the artificial intelligence-based model, a characteristic of the artificial intelligence-based model may be determined depending on the number of nodes in the artificial intelligence-based model, the number of links in the artificial intelligence-based model, a correlation between the nodes and the links, or a value of a weight assigned to each of the links. For example, if there exist two artificial intelligence-based models in which the number of nodes is the same as the number of links and weight values of links are different, the two artificial intelligence-based models may be recognized as being different from each other.

The artificial intelligence-based model may be implemented with a set of one or more nodes. A partial set of the nodes constituting the artificial intelligence-based model may constitute a layer. Some of the nodes constituting the artificial intelligence-based model may constitute one layer, based on distances from the initial input node. For example, a set of nodes each having a distance of “n” from the initial input node may constitute an n-th layer. The distance from the initial input node may be defined by the minimum number of links through which information passes to arrive at the corresponding node from the initial input node. However, the definition of the layer provided herein is an example, and the order of layers in the artificial intelligence-based model may be defined in other ways. For example, a layer of nodes may be defined by a distance from the final output node.

A set of neurons or nodes may be defined by the expression called a layer.

The initial input node may mean one or more nodes, to which data are directly input without passing through a link in a relationship with any other nodes, from among nodes in the artificial intelligence-based model. Alternatively, in an artificial intelligence-based model network, the initial input node may mean nodes which do not include any other input nodes connected by a link in a relationship between nodes based on a link. As in the above description, the final output node may mean one or more nodes, which do not include an output node in relation with any other nodes, from among the nodes in the artificial intelligence-based model. Also, a hidden node may mean nodes constituting the artificial intelligence-based model, not the initial input node and the final output node.

In the artificial intelligence-based model, the number of nodes of the input layer may be the same as the number of nodes of the output layer, and the number of nodes may decrease and then increase as it goes from the input layer toward the hidden layer.

In the artificial intelligence-based model, the number of nodes of the input layer may be less than the number of nodes of the output layer, and the number of nodes may decrease as it goes from the input layer toward the hidden layer.

In the artificial intelligence-based model, the number of nodes of the input layer may be more than the number of nodes of the output layer, and the number of nodes may increase as it goes from the input layer toward the hidden layer.

The artificial intelligence-based model may be a combination of the above artificial intelligence-based models.

The artificial intelligence-based model may include a deep neural network (DNN) (or a deep artificial intelligence-based model). The deep neural network may mean an artificial intelligence-based model including a plurality of hidden layers in addition to the input layer and the output layer. If the deep neural network is used, latent structures of data may be identified. That is, a latent structure of an image (e.g., whether any object is in an image) may be identified. The deep neural network may include a convolutional neural network (CNN), a recurrent neural network (RNN), a transformer, etc. The above description of the deep neural network is provided only as an example, and the present disclosure is not limited thereto.

The artificial intelligence-based model may be represented by any suitable network structure among the above network structures including the input layer, the hidden layer, and the output layer.

A neural network which is capable of being used in the artificial intelligence-based model may be trained by at least one of supervised learning, unsupervised learning, semi-supervised learning, transfer learning, active learning, and/or reinforcement learning. The training of the neural network may correspond to a process of applying the knowledge, which is necessary for the neural network performs a specific operation, to the neural network.

The neural network may be trained to minimize errors of the output. The training of the neural network may correspond to the process of updating a weight of each node of the neural network by (1) iteratively inputting training data to the neural network, (2) calculating an output of the neural network associated with the training data and an error of a target, and (3) backpropagating an error of the neural network in the direction from the output layer of the neural network to the input layer as the direction of reducing the error.

In the case of the supervised learning, training data in which a correct answer is labeled in each training data (e.g., labeled training data are used) may be used; in the case of the unsupervised learning, a correct answer may not be labeled in each training data.

For example, in the case of the supervised learning associated with data classification, training data may be data in which a category is labeled for each training data. An error may be calculated by inputting the labeled training data to the neural network and comparing the output (category) of the neural network with the label of the training data.

As another example, in the case of the unsupervised learning associated with data classification, an error may be calculated by comparing the training data as an input with the output of the neural network. The calculated error may be backpropagated in the reverse direction (e.g., in the direction from the output layer to the input layer) in the neural network, and a connection weight of each node in each layer of the neural network may be updated by the backpropagation. The amount of change in the updated connection weight of each node may be determined depending on a learning rate. The input data calculation of the neural network and the backpropagation of the error may constitute a training epoch. The learning rate may be differently applied depending on the number of iterations of the training epoch of the neural network. For example, in the early stages of training of the neural network, a high learning rate may be used to increase efficiency, that is, for the neural network to quickly secure a given level of performance; in the later stages of training a low learning rate may be used to increase accuracy.

In the training of the neural network, in general, training data may be a subset of actual data (e.g., data to be processed by using the trained neural network), and thus, an error of the training data may decrease. However, there may be a training epoch in which an error of the actual data increase. Overfitting is a phenomenon in which the error of the actual data increases due to excessive learning on the training data. For example, a phenomenon in which a neural network which has learned a cat by showing a yellow cat does not recognize a cat except for the yellow cat after seeing the cat may be a kind of overfitting. The overfitting may act as a cause of increasing an error of a machine learning algorithm. Various optimization methods may be used to prevent the overfitting. A method of increasing training data may be used to prevent the overfitting; alternatively, regularization, dropout that some nodes of a network are deactivated in the process of learning, and a batch normalization layer may be utilized.

The object detection model may correspond to an artificial intelligence-based model pre-trained to detect an object in an image (e.g., a photographic image) by using a dataset.

The dataset may mean a set of data for performing training and verification of the neural network. The dataset may include a training dataset and/or a verification dataset. The training dataset may be a set of data including a training image and information about objects in the training image. For example, the training dataset may be a set of data which are used in the process of training the object detection model. The verification dataset may be a set of data which are used to evaluate the object detection model.

The object detection model may include an artificial intelligence-based model pre-trained to receive an image and to detect an object in the image. For example, the object detection model may include an artificial intelligence-based model of the R-CNN (region-based CNN) family and an artificial intelligence-based model of the You Only Look Once (YOLO) family. However, the type of the object detection model is not limited thereto.

The object detection model may generate a bounding box corresponding to an object. For example, the object detection model may be trained or operate to receive an image and to output a bounding box corresponding to an object in the image.

The object may mean an object captured by a camera. The object may mean a something which exists or is conceivable in a real or virtual world. For example, the object may include smoke, flame, a vehicle, a license plate, etc. However, the type of the object is not limited thereto.

Object information which is information associated with an object may include information about a class (also referred to as a classification type, object classification type, or object type) of the object (e.g., smoke, firework, a vehicle, or a license plate), location information including the coordinates of the object (e.g., a bounding box), size information about the size of the object, area information about an area of the object, shape information about the shape of the object, identification (ID) information (e.g., an identifier) for identifying the object, etc.

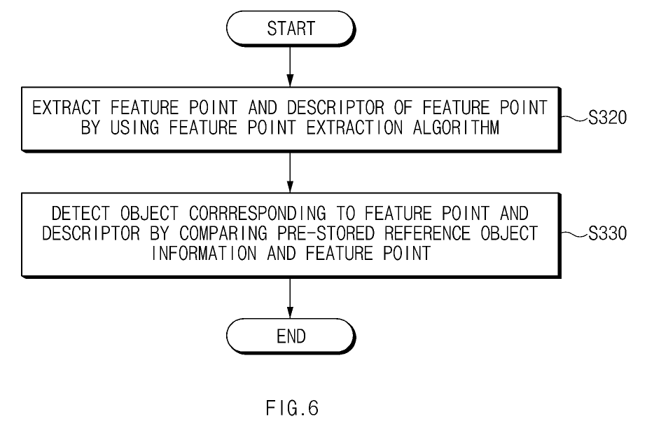

Referring to FIG. 6, the fire detection apparatus 100 may extract a feature point and a descriptor of the feature point from the image by using the feature point extraction algorithm (S320).

The feature point extraction algorithm may include scale-invariant feature transform (SIFT).

The feature point may be coordinates corresponding to each of portions which are characterized in the image. The feature point may be represented by a vector including information about a direction, a magnitude, a gradient, etc. The gradient may mean a vector of results of partially differentiating the loss function with respect to each parameter. The gradient may point out the upward direction of the steepest slope on the surface represented by the loss function.

The descriptor of the feature point may mean information for describing each feature point. For example, the descriptor of the feature point may include information about directivity, a magnitude, and/or a relationship between surrounding pixels, for each feature point.

The fire detection apparatus 100 may detect an object corresponding to the feature point and the descriptor by comparing the pre-stored (e.g., pre-determined) reference object information with the feature point and the descriptor (S330).

The reference object information which is information mapped to the object may include information about the object, such as a kind (e.g., type), a location, a size, a shape, and/or an ID.

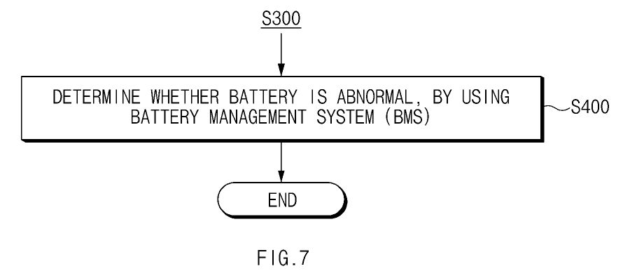

Referring to FIG. 7, after S300 in which the object included in the image is detected by using the algorithm for object recognition, the fire detection apparatus 100 may determine whether a battery (e.g., a battery of the vehicle) is abnormal, by using a battery management system (BMS).

The battery management system may refer to a system which monitors one or more properties, such as a temperature, a voltage, a current, etc. of a battery mounted on the vehicle. The battery management system may be installed on the vehicle. The battery management system may be controlled by the processor 130.

If the result of checking the battery by using the battery management system indicates that all values (e.g., battery parameters of a battery, such as a temperature, a voltage, a current, state of charge (SoC), state of health (SoH), impedance, battery cell balance, etc.) are within a normal range (e.g., a predetermined, expected, or safe range of values), the fire detection apparatus 100 may determine that the battery is normal (not abnormal).

If the result of checking the battery by using the battery management system indicates that at least one value (e.g., a temperature, a voltage, or a current of a battery) is out of the normal range, the fire detection apparatus 100 may determine that the battery is abnormal.

An abnormal state of the battery may indicate that there is a possibility of an outbreak of fire due to the battery. In other words, an abnormal battery may have (e.g., may be determined to have) a fire risk that is above a threshold level. An abnormal state of a battery may indicate that one or more property values (e.g., temperature, voltage, current, etc.) are outside of a predetermined (e.g., normal, expected, safe, etc.) range.

Returning to FIG. 2, the fire detection apparatus 100 may determine presence of any fire events, based on a class of the object (S500).

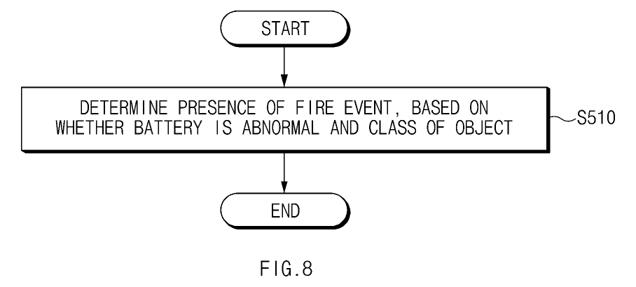

Referring to FIG. 8, the fire detection apparatus 100 may determine presence of any fire events, based on whether the battery is abnormal and the class of the object (S510).

For example, if the battery is not abnormal and the class of the object is smoke or flame, the fire detection apparatus 100 may determine that the fire breaks out in any other vehicle rather than the vehicle.

For another example, if the battery is abnormal and the class of the object corresponds to smoke or flame, the fire detection apparatus 100 may determine that the fire breaks out in the vehicle.

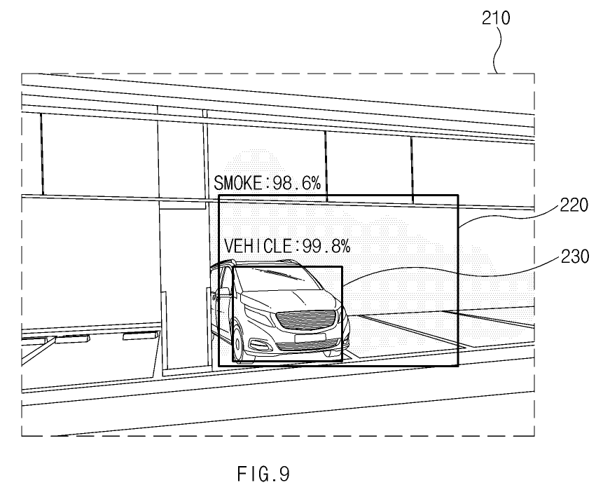

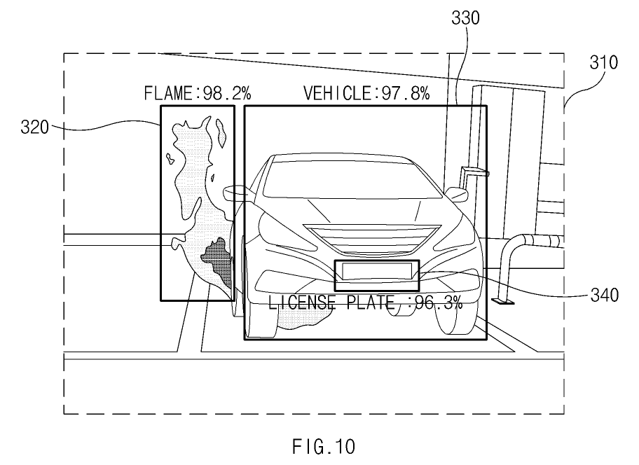

An object detection result is described herein in detail with reference to FIGS. 9 and 10. FIG. 9 is a diagram illustrating a result of detecting an object included in an image by using an example algorithm for object recognition. FIG. 10 is a diagram illustrating a result of detecting an object included in an image by using an example algorithm for object recognition.

Referring to FIG. 9, the fire detection apparatus 100 may detect objects 220 and 230 included in an image 210 by using the algorithm for object recognition. A class of the first object 220 may be smoke, and a class of the second object 230 may be a car (vehicle). The fire detection apparatus 100 may determine whether a battery is abnormal, by using the battery management system.

Based on determination that the battery is not abnormal, the fire detection apparatus 100 may determine that the fire breaks out (e.g., presence of a fire event) in a vehicle corresponding to the second object 230 (e.g., a target vehicle) rather than in the vehicle equipped with the camera 110.

Based on determination that the battery is abnormal, the fire detection apparatus 100 may determine that the fire breaks out in the vehicle equipped with the camera 110.

The fire detection apparatus 100 may transmit a notification (e.g., message-type data, image-type data, or voice-type data) notifying the outbreak of fire together with location information of the vehicle corresponding to the vehicle equipped with the camera 110 and/or the vehicle corresponding to the second object 230 to an external device (e.g., a device corresponding to a police station, a fire station, a management office, an emergency situation room of a nearby major agency, or an identifiable customer).

Referring to FIG. 10, the fire detection apparatus 100 may detect objects 320, 330, and 340 included in an image 310 by using the algorithm for object recognition. A class of the third object 320 may be flame, a class of the fourth object 330 may be a car (vehicle), and a class of the fifth object 340 may be a license plate. The fire detection apparatus 100 may determine whether a battery is abnormal, by using the battery management system.

Based on determination that the battery is not abnormal, the fire detection apparatus 100 may determine that the fire breaks out in a vehicle corresponding to the fourth object 330 rather than the vehicle equipped with the camera 110.

Based on determination that the battery is abnormal, the fire detection apparatus 100 may determine that the fire breaks out in the vehicle equipped with the camera 110.

Based on a determination of presence of a fire event, the fire detection apparatus 100 may take one or more actions. For example, the fire detection apparatus 100 may take one or more remedial actions, such as sending a notification (e.g., an alert, an emergency message, etc.), controlling one or more devices or components of the vehicle (e.g., locking or unlocking doors, rolling windows up or down, activating or deactivating fans, opening or closing ventilation, etc.). The fire detection apparatus 100 may, for example, transmit a notification (e.g., message-type data, image-type data, or voice-type data) notifying the outbreak of fire together with location information of the vehicle corresponding to the vehicle equipped with the camera 110 and/or the vehicle corresponding to the fourth object 330 to an external device (e.g., a device corresponding to a police station, a fire station, a management office, an emergency situation room of a nearby major agency, or a device associated with the vehicle owner and/or driver). For example, the fire detection apparatus 100 may identify the number described in the fifth object 340. The fire detection apparatus 100 may obtain a telephone number of a corresponding customer by comparing pre-stored customer information (e.g., a vehicle number and a telephone number of the customer) and the number identified from the fifth object 340. The fire detection apparatus 100 may transmit a notification notifying the outbreak of fire together with location information of the vehicle equipped with the camera 110 and/or the vehicle corresponding to the fourth object 330 by using the telephone number of the customer.

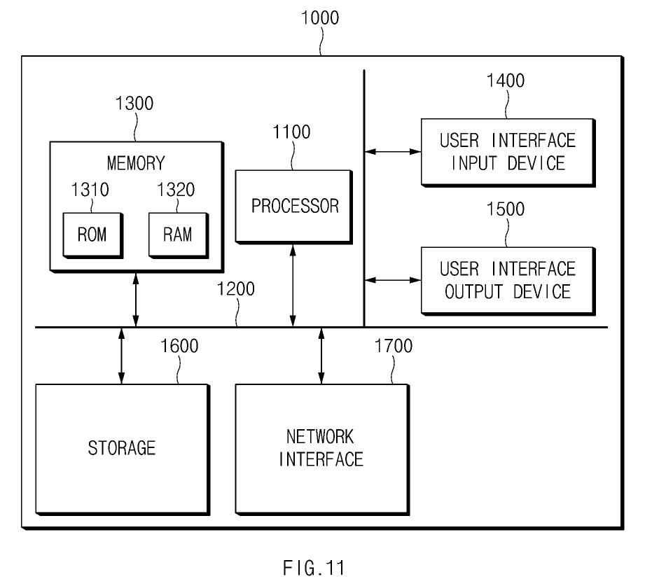

FIG. 11 illustrates an example computing system. One of more components of the configuration of the fire detection apparatus may be implemented with a computer system 1000 as shown in FIG. 11.

Referring to FIG. 11, the computing system 1000 may include at least one processor 1100, a memory 1300, a user interface input device 1400, a user interface output device 1500, storage 1600, and a network interface 1700, which are connected via a bus 1200.

The processor 1100 may be a central processing unit (CPU) or a semiconductor device which processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Thus, the operations of the method or the algorithm described herein may be embodied directly in one or more hardware modules, one or more software modules executed by the processor 1100, or a combination thereof. The software module may reside in a storage medium (e.g., the memory 1300 and/or the storage 1600) such as a RAM, a flash memory, a ROM, an EPROM, an EEPROM, a register, a hard disk, a removable disk, and a CD-ROM.

The example storage medium may be coupled to the processor 1100. The processor 1100 may read information from the storage medium and may write information in the storage medium. As another method, the storage medium may be integrated with the processor 1100. The processor and the storage medium may reside in an application specific integrated circuit (ASIC). The ASIC may reside within a user terminal. As another method, the processor and the storage medium may reside in the user terminal as separate components.

According to an aspect of the present disclosure, a fire detection apparatus may include a camera mounted on a vehicle, a processor, and a memory.

The processor may obtain an image from the camera, may detect an object included in the image by using an algorithm for object detection including at least one of an object detection model and a feature point extraction algorithm, and may determine whether to fire based on a class of the object.

The processor may wait until the vehicle enters a power-off state (IG OFF), if the vehicle is in a power-on state (IG ON).

The processor may obtain the image by using the camera every predetermined period, if the vehicle is in a power-off state (IG OFF).

The object detection model may include an artificial intelligence-based model pre-trained to detect the object in the image.

The processor may detect the object included in the image by inputting the image to the object detection model.

The processor may extract a feature point and a descriptor of the feature point from the image by using the feature point extraction algorithm and may detect the object corresponding to the feature point and the descriptor by comparing pre-stored reference object information with the feature point and the descriptor.

The processor may determine whether a battery is abnormal, by using a battery management system (BMS), after detecting the object.

The processor may determine whether to fire, based on whether the battery is abnormal or the class of the object.

The processor may determine that a fire breaks out in another vehicle being not the vehicle, if the battery is not abnormal and the class of the object is smoke or flame.

The processor may determine that a fire breaks out in the vehicle, if the battery is abnormal and the class of the object is smoke or flame.

According to an aspect of the present disclosure, a method of detecting a fire may include obtaining an image from a camera equipped with a vehicle, detecting an object included in the image by using an algorithm for object detection including at least one of an object detection model and a feature point extraction algorithm, and determining whether to fire based on a class of the object.

Before the obtaining of the image from the camera equipped with the vehicle, the method may further include waiting until the vehicle enters a power-off state (IG OFF), if the vehicle is in a power-on state (IG ON).

The obtaining of the image from the camera equipped with the vehicle may include obtaining the image by using the camera every predetermined period, if the vehicle is in a power-off state (IG OFF).

The detecting of the object included in the image by using the algorithm for object recognition may include detecting the object included in the image by inputting the image to the object detection model.

The detecting of the object included in the image by using the algorithm for object recognition may include extracting a feature point and a descriptor of the feature point from the image by using the feature point extraction algorithm, and detecting the object corresponding to the feature point and the descriptor by comparing pre-stored reference object information with the feature point and the descriptor.

After the detecting of the object included in the image by using the algorithm for object recognition, the method may further include determining whether a battery is abnormal, by using a battery management system (BMS).

The determining whether to fire based on the class of the object may include determining whether to fire, based on whether the battery is abnormal or the class of the object.

The determining whether to fire based on whether the battery is abnormal or the class of the object may include determining that a fire breaks out in another vehicle being not the vehicle, if the battery is not abnormal and the class of the object is smoke or flame.

The determining whether to fire based on whether the battery is abnormal or the class of the object may include determining that a fire breaks out in the vehicle, if the battery is abnormal and the class of the object is smoke or flame.

This technology may minimize the damage capable of occurring due to the fire by detecting a fire of a vehicle by using a camera mounted on the vehicle and contacting the outside (e.g., a fire station, an owner of the vehicle where the fire breaks out, or a management office).

Hereinabove, although the present disclosure has been described with reference to one or more example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A fire detection apparatus comprising:
a camera mounted on a vehicle;
a processor; and
a memory storing at least one instruction that is configured, when executed by the processor communicating with the memory, to cause the fire detection apparatus to:
obtain, via the camera, one or more images of an environment of the vehicle;
detect, based on at least one of an object detection model or a feature point extraction algorithm, an object in the one or more images;
determine, based on an object classification type of the object, presence of a fire event; and
cause, based on the determined presence of the fire event, the vehicle to perform one or more remedial actions.

2. The fire detection apparatus of claim 1, wherein the at least one instruction is configured, when executed by the processor communicating with the memory, to cause the fire detection apparatus to obtain the one or more images by:
obtaining the one or more images while the vehicle is in a parked state.

3. The fire detection apparatus of claim 1, wherein the at least one instruction is configured, when executed by the processor communicating with the memory, to cause the fire detection apparatus to obtain the one or more images by:
obtaining, via the camera, the one or more images at predetermined time intervals.

4. The fire detection apparatus of claim 1, wherein the object detection model comprises an artificial intelligence-based model that is pre-trained to detect objects in photographic images.

5. The fire detection apparatus of claim 1, wherein the at least one instruction is configured, when executed by the processor communicating with the memory, to cause the fire detection apparatus to detect the object by:
inputting the one or more images to the object detection model.

6. The fire detection apparatus of claim 1, wherein the at least one instruction is configured, when executed by the processor communicating with the memory, to cause the fire detection apparatus to detect the object by:
extracting, from the one or more images and using the feature point extraction algorithm, a feature point and a descriptor of the feature point; and
detecting the object corresponding to the feature point and the descriptor by comparing pre-determined reference object information with the feature point and the descriptor.

7. The fire detection apparatus of claim 1, wherein the at least one instruction is configured, when executed by the processor communicating with the memory, to further cause the fire detection apparatus to, after detecting the object, determine, via a battery management system of the vehicle, whether at least one battery parameter of a battery is within a predetermined range.

8. The fire detection apparatus of claim 7, wherein the at least one instruction is configured, when executed by the processor communicating with the memory, to cause the fire detection apparatus to determine presence of the fire event by:
determining presence of the fire event further based on whether the at least one battery parameter of the battery is within the predetermined range.

9. The fire detection apparatus of claim 8, wherein the vehicle is a first vehicle, and wherein the at least one instruction is configured, when executed by the processor communicating with the memory, to cause the fire detection apparatus to determine presence of the fire event by:
determining, based on the at least one battery parameter of the battery being outside the predetermined range and the object classification type being smoke or flame, presence of the fire event at a second vehicle different from the first vehicle.

10. The fire detection apparatus of claim 8, wherein the at least one instruction is configured, when executed by the processor communicating with the memory, to cause the fire detection apparatus to determine presence of the fire event by:
determining, based on the at least one battery parameter of the battery being outside the predetermined range and the object classification type being smoke or flame, presence of the fire event at the vehicle.

11. A method performed by an apparatus of a vehicle, the method comprising:
obtaining, via a camera mounted on the vehicle, one or more images of an environment of the vehicle;
detecting, based on at least one of an object detection model or a feature point extraction algorithm, an object in the one or more images;
determining, based on an object classification type of the object, presence of a fire event; and
causing, based on the determined presence of the fire event, the vehicle to perform one or more remedial actions.

12. The method of claim 11, wherein the obtaining of the one or more images comprises:
obtaining the one or more images while the vehicle is in a parked state.

13. The method of claim 11, wherein the obtaining of the one or more images comprises:
obtaining, via the camera, the one or more images at predetermined time intervals.

14. The method of claim 11, wherein the object detection model comprises an artificial intelligence-based model that is pre-trained to detect objects in photographic images.

15. The method of claim 11, wherein the detecting of the object comprises:
inputting the one or more images to the object detection model.

16. The method of claim 11, wherein the detecting of the object comprises:
extracting, from the one or more images and using the feature point extraction algorithm, a feature point and a descriptor of the feature point; and
detecting the object corresponding to the feature point and the descriptor by comparing pre-determined reference object information with the feature point and the descriptor.

17. The method of claim 11, further comprising:
after the detecting of the object, determining, via a battery management system of the vehicle, whether at least one battery parameter of a battery is within a predetermined range.

18. The method of claim 17, wherein the determining of presence of the fire event comprises:
determining presence of the fire event further based on whether the at least one battery parameter of the battery is within the predetermined range.

19. The method of claim 18, wherein the vehicle is a first vehicle, and wherein the determining of presence of the fire event comprises:
determining, based on the at least one battery parameter of the battery being outside the predetermined range and the object classification type being smoke or flame, presence of the fire event at a second vehicle different from the first vehicle.

20. A vehicle comprising:
a camera;
a temperature sensor;
a processor; and
a memory storing at least one instruction that is configured, when executed by the processor communicating with the memory, to cause the vehicle to:
obtain, via the camera, one or more images of an environment of the vehicle;
detect, based on at least one of an object detection model or a feature point extraction algorithm, an object in the one or more images;
determine, based on a measured temperature of the temperature sensor and based on an object classification type of the object, presence of a fire event; and
cause, based on the determined presence of the fire event, the vehicle to perform an autonomous driving operation of the vehicle.
